(19) United States
(12) Patent Application Publication
(10) Pub. No.: US 2005/0062397 A1
(43) Pub. Date: Mar. 24, 2005

(54) Fluorescent lamp and lighting device

(75) Inventors: Masahiro Izumi, Kanagawa-Ken (JP); Takashi Yorifuji, Kanagawa-Ken (JP); Shoji Naoki, Kanagawa-Ken (JP); Yoshihito Nishihara, Hyogo-Ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOSHIBA LIGHTING & TECHNOLOGY CORPORATION, Tokyo (JP)

(21) Appl. No.: 10/946,242

(22) Filed: Sep. 22, 2004

(30) Foreign Application Priority Data
Sep. 24, 2003 (JP) 2003-331779
Dec. 26, 2003 (JP) 2003-433956

(51) Int. Cl. H01J 1/62; H01J 63/04; H01J 17/16

(52) U.S. Cl. 313/485; 313/635

(57) ABSTRACT

A fluorescent lamp has a glass bulb, electrodes provided therein, a discharge medium enclosed inside the glass bulb and containing 0.009 mg/cm² or less of mercury per inner surface area of the bulb and an inert gas, and the fluorescent layer provided on the inner surface. The fluorescent layer contains the phosphor fine particles and a binding agent preferably composed of alumina fine particles having a BET value of 60 m²/g or more and alumina fine particles having a BET value of 40 m²/g or less. A lighting device incorporates the fluorescent lamp described above. According to such fluorescent lamp and lighting device, the luminous-flux rising characteristics at an initial lighting stage and film adhesion strength of a fluorescent layer can be improved by specifically defining the fluorescent layer, phosphor fine particles, and alumina fine particles.

### BACKGROUND OF THE INVENTION

1. Field of the Invention

The present invention relates to a fluorescent lamp having a glass bulb and a fluorescent layer formed on an inner surface thereof, the fluorescent layer containing an improved phosphor (fluorescent) material and a binder, preferably of alumina binder, and also relates to a lighting device incorporating the fluorescent lamp.

2. Related Art

Generally, fluorescent lamps are each composed of a tube-shaped glass bulb, a fluorescent layer formed on an inner surface thereof, and a discharge medium composed of an inert gas such as argon and mercury, is enclosed in the glass bulb. The fluorescent lamp functions as a light source which primarily uses an emission wavelength of approximately 254 nm in an emission spectrum of mercury caused by discharge as an excitation source for a phosphor material.

Such fluorescent lamps are kept or placed in store or warehouses, after being produced, and are then mounted to equipments or apparatus for lighting. However, a phenomenon is liable to occur at an initial lighting stage in which the brightness at a central portion of a bulb is low (dark) as compared with that at an end portion of the bulb, that is, the distribution of brightness is not uniform, and inferior rising luminous-flux characteristics are disadvantageously observed.

In addition, after a fluorescent lamp mounted on a lighting equipment or a lighting apparatus has been held for a long period of time without performing lighting, for example, when the lamp is turned on particularly at a place at which the ambient temperature is low, non-uniform brightness of the lamp may be observed in some cases, though not so significant as compared with the phenomenon which occurs at an initial lighting stage.

However, when temperatures of various parts of the lamp become approximately equivalent to each other about 10 minutes after lighting of the fluorescent lamp has started, the brightness becomes approximately uniform, and hence, the phenomenon described above is not visually observed at all.

The phenomenon or inconvenience of partial brightness lowering at an initial lighting time described above has not occurred in a conventional bulb containing an excessive amount of mercury. In recent years, however, since the amount of mercury enclosed in a fluorescent lamp is decreased to a minimum essential level in view of environmental conservation, the mercury evaporated in a bulb is liable to be adsorbed on a fluorescent layer when aging or test lighting is performed for a finished fluorescent lamp. Accordingly, one of the reasons causing such phenomenon or inconvenience as described above has been considered that the amount of the mercury contributing to emitting light becomes deficient just after the lamp is turned on.

Further, in addition to the reason described above, since end portions of the glass bulb are provided with bases or placed at outer sides of a packaging box, the rate of decrease in temperature is fast, and the mercury evaporated inside the bulb tends to be concentrated to the end portions. Hence, it has been believed that the phenomenon described above may occur due to the non-uniform distribution of the mercury in the bulb. That is, the concentration of the mercury is high at the two end portions of the bulb and is low at the central portion thereof.

In order to overcome the above-mentioned defective matters in which the mercury is adsorbed to the fluorescent layer, prior art provides a technique, for example, disclosed in Japanese Unexamined Patent Application (KOKAI) Publication No. 2001-57178 in which a binding agent mixed with phosphor fine particles for forming the fluorescent layer is primarily formed of α-alumina.

In addition, in order to solve the problem of the non-uniform distribution of the mercury in the bulb, prior art also provides a technique, for example, disclosed in Japanese Patent No. 3438717 in which the specific surface area (BET value) of fine particles forming the fluorescent layer is controlled.

However, according to the technique disclosed in Japanese Unexamined Patent Application Publication No. 2001-57178, the film strength of a fluorescent layer containing α-alumina used as a binder has not been taken into consideration at all, and problems of quality and productivity of fluorescent lamps may arise in some cases.

In addition, according to the technique disclosed in Japanese Patent No. 3438717, after the inside of the bulb is evacuated, impurities such as water and carbon are liable to remain in boron oxides or magnesium oxides which are used for controlling the specific surface area of fine particles, and as a result, lamp properties may be degraded in some cases due to the influence of such remaining components.

In order to form the fluorescent layer described above, when γ-alumina is also used as a binding agent which is mixed with phosphor fine particles, the degradation of luminous-flux rising characteristics is liable to occur. In addition, when α-alumina is used as a binding agent, the adhesion strength of the phosphor material to the inner surface of the bulb is small, and due to the change in pressure which occurs when the bulb is evacuated or an inert gas is injected thereinto, or due to an impact applied to the fluorescent lamp when it is transported, phenomena such as cracking and/or peeling of the fluorescent layer occur, resulting in degradation of the light-emitting lamp properties and the outer appearance thereof.

### SUMMARY OF THE INVENTION

The present invention was therefore conceived in consideration of the circumstances of the prior art technology and an object of the present invention is to provide a fluorescent lamp, and a lighting device incorporating the fluorescent lamp mentioned above, the fluorescent lamp being capable of improving the luminous-flux rising characteristics at an initial lighting stage and the film adhesion strength of a fluorescent layer by specifying the fluorescent layer, phosphor fine particles, and fine particles used as a binding agent, preferably of alumina, the phosphor fine particles and the fine particles collectively forming the fluorescent layer, preferably of alumina.

The above and other objects can be achieved according to the present invention by providing, in one aspect, a fluorescent lamp which comprises a glass bulb; electrodes provided in the glass bulb; a discharge medium enclosed inside the glass bulb, the discharge medium containing an inert gas and 0.009 mg/cm² or less of mercury per inner surface area of the glass bulb; and a fluorescent layer provided on the inner surface of the glass bulb, the fluorescent layer containing phosphor fine particles and a binding agent composed of fine particles having a BET value of 60 m²/g or more and fine particles having a BET value of 40 m²/g or less.

According to the present invention of this aspect, since the binding agent contained in the fluorescent layer comprises mixed alumina containing γ-alumina fine particles and α-alumina fine particles, the γ-alumina fine particles having a BET value (specific surface area of fine particles) of 60 m²/g or more, the α-alumina fine particles having a BET value of 40 m²/g or less, without degrading the film adhesion strength, the rate of diffusion of mercury can be increased, and hence, the total luminous flux can be made equivalent to that obtained in the case in which γ-alumina is only used.

Further, besides α-alumina (α-Al₂O₃), as a material having a BET value of 40 m²/g or less, when at least one of yttria (Y₂O₃) and calcium pyrophosphate (Ca₂P₂O₇) is used, the advantageous effect is obtainable, which is equivalent to that obtained by the use of α-alumina. In addition, the content of the material described above is preferably 5 mass % or less with respect to the phosphor fine particles.

When one mass % or less of boric acid is added to the binding agent with respect to the phosphor fine particles, the same effect as that described above can also be obtained.

Further, 0.009 mg/cm² or less of mercury per inner surface area of the bulb, which is defined by the present invention, is a minimum essential amount for variously rated fluorescent lamps which do not contain an excessive amount of mercury in consideration of environmental conservation.

In the first aspect of the present invention described above and the following aspects of the present invention, the definitions of terms and the technical meanings thereof are as follows unless otherwise particularly stated.

As a material for the glass bulb forming a discharge envelope, for example, there may be mentioned a soft glass such as a soda lime glass or a lead glass, or a hard glass such as a borosilicate glass, an aluminosilicate glass, or a quartz glass.

In addition, as the shape of the glass bulb, for example, there may be mentioned a straight type, a circular type, a U-shaped type, a W-shaped type, a WU-shaped type, or a so-called compact type composed of straight bulbs connected to each other. In addition, of course, the present invention may also be applied to various lamps, such as a lamp having an airtight container which is formed by sealing a circular type glass bulb or an opening end of a glass bulb having one closed end with a metal stem or an end cap, a flat type lamp formed by bonding two plates to each other with a spacer provided therebetween, and a flat type lamp having a plate provided with a discharged groove in a U-shape, which is formed by polymerization or by bonding a glass plate. In addition, a sealing method is not particularly limited, and a sealing portion may be sealed using a stem, an end cap, or the like, or sealing may be performed by compression sealing.

Further, the present invention can attain a remarkable effect when applied to a fluorescent lamp having a long bulb length (almost equal to discharge path length) in which mercury vapor is not easily diffused. In a preferred example, the bulb length is, in the linear straight state, of more than 600 mm, and preferably, of more than 1000 mm.

As a phosphor (fluorescent) material for forming the fluorescent layer, various kinds of known materials may by used, and for example, three-wavelength visible ray emission type rare earth phosphor materials and halophosphate phosphor materials may be used for general purpose fluorescent lamps. In addition, in accordance with grades and applications of fluorescent lamps, optional phosphor materials may be used.

Especially, the three-wavelength emission visible ray type rare earth phosphor material easily absorbs the mercury vapor and, hence the mercury vapor is hardly diffused, so that the effects of the present invention described above could be further attained.

Further, the present invention may be applied to a fluorescent lamp which also contains a protective layer or film made of alumina or the like, a transparent conductive layer or film made of a Nesa film or the like, and/or a reflective coating layer or film between the inner surface of the glass bulb and the fluorescent layer or film.

In addition, as an inert gas enclosed in the bulb used as the discharge medium, at least one of argon (Ar), neon (Ne), krypton (Kr), xenon (Xe), nitrogen (N₂), and the like may be used.

Furthermore, although the form of the mercury enclosed in the bulb may be a liquid form, in order to quantitatively enclose a small amount of mercury, amalgam formed with at least one amalgam-forming material among zinc (Zn), lead (Pb), tin (Sn), bismuth (Bi), and Indium (In) in pellet form may be enclosed in the bulb. In addition, a mercury-dispensing compound made of a mercury alloy in a strip shape, such as GEMEDIS (trade name), may also be used.

In addition, the mercury may be enclosed in the bulb through an exhaust line of the stem, may be placed in the exhaust line, may be provided on a stem surface or a lead wire, or may be disposed on the fluorescent layer or the like when it is not observed from the outside due to the presence of a cap provided for the lamp.

In addition, as the electrodes, a hot cathode type having a coiled filament or a cold cathode type may be used, and the electrode may be formed inside the bulb or on the exterior surface of the bulb.

Furthermore, the fluorescent lamp of the present invention may be formed as fluorescent lamps for various applications, such as a starter type fluorescent lamp, a rapid start type fluorescent lamp, and a high-output type fluorescent lamp.

In accordance with a second aspect of the present invention, there is provided a fluorescent lamp, which comprises: a glass bulb; electrodes provided in the glass bulb; a discharge medium enclosed inside the glass bulb, the discharge medium containing an inert gas and 0.009 mg/cm² or less of mercury per inner surface area of the glass bulb; and a fluorescent layer provided on the inner surface of the glass bulb, the fluorescent layer having a BET value of 1.2 to 1.7 m²/g and containing phosphor fine particles and a binding agent.

In the fluorescent lamp according to the second aspect of the present invention, the BET value (specific surface area of fine particles) of the fluorescent layer is defined, and accordingly, the degradation in luminous-flux rising characteristics of the lamp can be suppressed which is caused by the adsorption of the mercury to the fluorescent layer, and in addition, an effect of imparting a sufficient adhesion strength to the fluorescent layer can be obtained.

That is, when the BET value of this fluorescent layer is less than 1.2 m²/g, due to an insufficient adhesion strength of the fluorescent layer, problems such as peeling-off of the fluorescent layer may occur in some cases, and on the other hand, when the BET value is more than 1.7 m²/g, problems may arise at the initial lighting stage due to the adsorption of the mercury to the fluorescent layer. Hence, when the variation is also taken into consideration, the BET value is particularly preferably in the range of from approximately 1.4 to 1.6 m²/g.

In accordance with a third aspect of the present invention, there is provided a fluorescent lamp, which comprises: a glass bulb; electrodes provided in the glass bulb; a discharge medium enclosed inside the glass bulb, the discharge medium containing an inert gas and 0.009 mg/cm² or less of mercury per inner surface area of the glass bulb; and a fluorescent layer provided on the inner surface of the glass bulb, the fluorescent layer having a BET value of 1.2 to 1.7 m²/g and containing phosphor fine particles and a binding agent, the binding agent containing fine particles having a BET value of 60 m²/g or more and fine particles having a BET value of 40 m²/g or less.

In the fluorescent lamp according to the third aspect of the present invention, the BET values (specific surface areas of fine particles) of the phosphor material and the binding agent composed of alumina fine particles are defined, and substantially the same effects of the fluorescent lamps attained by the first and the second aspects of the present invention can be also obtained.

According to the fluorescent lamps of the aspects described above, the binding agent preferably comprises γ-alumina fine particles having a BET value of 60 m²/g or more and α-alumina fine particles having a BET value of 40 m²/g or less.

Since a mixture of γ-alumina fine particles and α-alumina fine particles is used as the binding agent, the degradation in luminous-flux rising characteristics can be suppressed, and in addition, the adhesion strength of the phosphor material can be improved. According to the fluorescent lamps described above, the average BET value of the binding agent is preferably in the range of from 40 to 80 m²/g.

In the present invention, the average BET value (specific surface area of fine particles) of the total alumina fine particles is defined, and accordingly, the degradation in luminous-flux rising characteristics can be suppressed which is caused by the adsorption of the mercury to the fluorescent layer at the initial lighting stage, and in addition, an effect of imparting sufficient adhesion strength to the fluorescent layer can be obtained.

That is, when the average BET value of the total alumina fine particles is less than 40 m²/g, due to an insufficient adhesion strength of the fluorescent layer, problems such as peeling-off of the fluorescent layer may occur, and on the other hand, when the BET value is more than 80 m²/g, problems may arise at the initial lighting stage due to the adsorption of the mercury to the fluorescent layer. Hence, when the variation is also taken into consideration, the BET value of the total alumina fine particles is particularly preferably in the range of from approximately 50 to 70 m²/g.

According to the above fluorescent lamps of the present invention, 3.0 mass % or less of the binding agent may be preferably added to the phosphor fine particles.

In the fluorescent lamps of the present invention, the amount of the total alumina fine particles used as the binding agent is defined, and as a result, the degradation in luminous-flux rising characteristics can be advantageously suppressed which is caused by the adsorption of the mercury to the fluorescent layer at the initial lighting stage.

When the amount of the total alumina fine particles is more than 3.0% on a mass % basis, problems may occur which are caused by the adsorption of the mercury to the fluorescent layer at the initial lighting stage. Accordingly, the amount of the total alumina fine particles is preferably in the range of from approximately 1 to 2.5 mass %.

According to the above fluorescent lamps of the present invention, 1.5 mass % or less of γ-alumina fine particles having a BET value of 60 m²/g or more is preferably added to the phosphor fine particles.

When the amount of γ-alumina fine particles having a BET value of 60 m²/g or more is 1.5 mass % or less with respect to the phosphor fine particles, the adsorption of mercury onto γ-alumina fine particles is suppressed, the rate of diffusion of mercury vapor inside the bulb is increased, and as a result, the delay of the rise in luminous flux at the initial lighting stage can be prevented which is caused by a temporary deficiency of mercury. Further, it may be preferred that the γ-alumina fine particles has 0.3 or more mass %.

The amount of α-alumina having a BET value of 40 m²/g or less is 1.5 mass % or less as described above and is preferably 1.0 mass % or less.

In accordance with a further aspect of the present invention, there is provided a lighting device which comprises: a lighting main body; one of the fluorescent lamps of the first to third aspects mentioned above fitted to the lighting main body; and a lighting circuit for the fluorescent lamp.

Since the lighting device comprises one of the fluorescent lamps described above, superior lighting can be performed having superior luminous-flux rising characteristics in which uniform brightness is obtained substantially over the entire bulb length at the initial lighting stage.

The lighting device may be a lighting device mounted to a ceiling, a lighting device depending from a ceiling, a lighting device mounted to a wall, or the like, and the fluorescent lamp may be exposed or covered with a dimmer, such as a globe, shade, or a reflection shade, which is provided for the main body.

In addition, the lighting device of the present invention may include a lighting device composed of a plurality of lamps, i.e., more than one, having the same rating or a device composed of a plurality of different lamps in terms of lamp powers.

Furthermore, according to the present invention, as the lighting circuit for supplying an electric power to the fluorescent lamp, for example, an electromagnetic ballast circuit or a high-frequency lighting circuit may be used. The lighting circuit may be provided in the main body or may be provided separately from the lighting device.

Furthermore, besides the lighting devices described above, the present invention may be applied to various lighting devices or equipments.

In the fluorescent lamps in which the specific surface areas of the phosphor fine particles and the fine particles, preferably of alumina fine particles, are primarily controlled and in which the amount of the enclosed mercury is controlled so as to be a minimum essential level in view of environmental conservation, the luminous-flux rising characteristics can be improved so that the brightness distribution right after the start of operation can be made substantially uniform along the entire length of the bulb, and in addition, the outer appearance quality can be improved by suppressing phenomena such as cracking in the fluorescent layer, thereby providing a superior fluorescent lamp.

According to the fluorescent lamps in which the amount of the fine particles such as alumina fine particles is controlled in addition to the controls of the specific surface areas of the fine particles and the amount of the mercury, the adsorption of the mercury to the γ-alumina fine particles can be suppressed, and the rate of diffusion of the mercury inside the bulb can be increased. Thus, a fluorescent lamp having the improved luminous-flux rising characteristics can be provided.

Since the lighting device according to the present invention comprises one of the fluorescent lamps described above, the luminous-flux rising characteristics can be improved so that the brightness distribution just after the start of operation can be made substantially uniform along the entire length of the bulb. Accordingly, a lighting device capable of performing the superior lighting can be provided.

### BRIEF DESCRIPTION OF THE DRAWINGS

In the accompanying drawings:

FIG. 1 is a front view, partially cutaway as cross-section, showing a straight type fluorescent lamp of an embodiment according to a first aspect of one embodiment of the present invention;

FIG. 2 is an enlarged cross-sectional view of the fluorescent lamp taken along the line II-II shown in FIG. 1;

FIG. 3 is a schematic front view showing a circular type fluorescent lamp of a second aspect of the present invention;

FIG. 4 is a schematic front view of a U-shaped type fluorescent lamp of a third aspect of the present invention; and

FIG. 5 is a perspective view showing a lighting device of an aspect of another embodiment of the present invention.

### DESCRIPTION OF THE PREFERRED EMBODIMENT

Preferred embodiments of the present invention will be described hereunder with reference to the accompanying drawings.

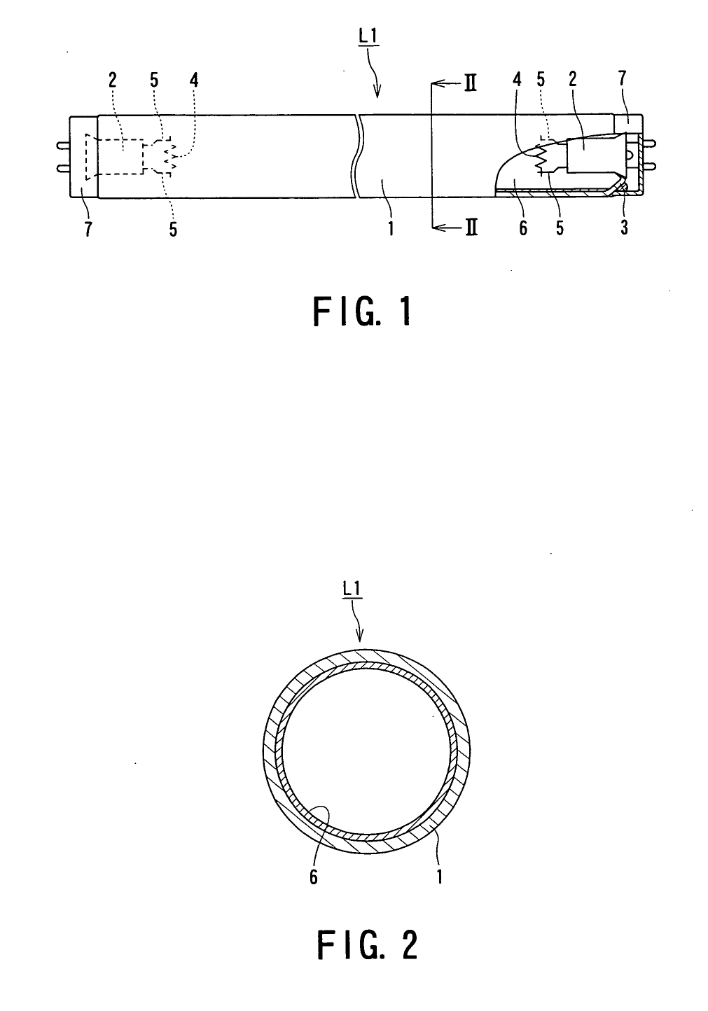

Referring to FIGS. 1 and 2, reference numeral 1 indicates a straight tube glass bulb made of a soda lime glass, which may be called merely glass bulb or bulb 1 hereinlater. A stem 2 made of a lead glass is disposed inside the glass bulb 1 and mounted to each end thereof. The bulb 1 and the stems 2 collectively form an air-tight container or envelope through sealing portions 3 formed between the glass bulb 1 and the stem 2. Further, these sealing portions 3 are covered by bases 7 at the both ends.

Reference numeral 4 indicates electrodes made of coil-shaped tungsten wires connected to lead wires 5 attached to the stems 2 at both longitudinal end of the glass bulb 1. A fluorescent layer 6 is formed on the inner surface of the bulb 1.

In order to form this fluorescent layer 6, first of all, phosphor fine particles made, for example, of a three-wavelength emission type rare earth phosphor material or a continuous-wavelength emission type halophosphate phosphor material, having a BET value of 0.8 to 1.2 m²/g, such as approximately 1.0 m²/g, is prepared. In addition, as a binding agent, 1.5 mass % or less, such as approximately 1.0 mass %, of γ-alumina fine particles having a BET value of 60 m²/g or more, preferably of 100 to 150 m²/g, for example, approximately 120 m²/g, and 1.5 mass % or less, such as approximately 1.0 mass %, of α-alumina fine particles having a BET value of 40 m²/g or less, preferably of 5 to 30 m²/g, for example, approximately 20 m²/g, are also prepared with respect to the total amount of the phosphor fine particles described above.

The phosphor fine particles and the binding agent thus prepared are mixed together and are then dispersed in polyethylene oxide (PEO) to form a dispersion. After the dispersion thus obtained is applied onto the inner surface of the bulb 1, drying and firing are performed, thus forming the fluorescent layer 6.

In addition, as the discharge medium, 0.009 mg or less of mercury per inner surface (cm²) of the bulb and a mixed inert gas of Ar and Ne are enclosed in the bulb 1 at a pressure of approximately 320 Pa.

After stored in a warehouse or the like, followed by shipment, the fluorescent lamp L1 having the above structure thus produced was mounted onto a lighting device or lighting equipment and was then turned on for lighting.

In an experience of the applicant, although the lighting test was performed several months after the production of the fluorescent lamp L1, the decrease in brightness at the central portion of the bulb 1 could not be visually observed just after the start of the lighting operation, and in addition, peeling-off of the fluorescent layer 6 did not occur. Thus, it was confirmed that the luminous-flux rising characteristics and the appearance quality can be effectively improved.

In addition, since such phenomenon as the adsorption of the mercury to the phosphor fine particles, the oxidation of the mercury, and the reaction thereof with sodium contained in the glass bulb 1 did not occur, it was recognized that the consumption of the mercury can be significantly reduced, and as a result, the amount of the mercury enclosed in the fluorescent lamp can be decreased to a minimum essential level.

Furthermore, in Table 1, there are shown the luminous-flux rising characteristics and the film adhesion strength of various lamps (1) to (7), which were prepared by changing the amount (mg/cm²) of enclosed mercury per inner surface area of the bulb and the ratios of the γ-alumina having a BET value of 60 m²/g or more and the α-alumina having a BET value of 40 m²/g or less to the total amount of the phosphor fine particles (solid component) which were used for forming the fluorescent layer.

As a test lamp, a straight type FL40SS fluorescent lamp was used, and the total luminous flux was a relative value (with respect to the highest total luminous flux among the lamps, which was regarded as 100%) of each of the lamps (1) to (7) measured at stable lighting (60 minutes after the start of operation under rated conditions), and the luminous-flux rising characteristics was represented by a ratio of luminous flux obtained 60 seconds after the start of lighting to that obtained at the stable lighting.

TABLE 1

| | | | Enclosed Mercury | | | |
|---|---|---|---|---|---|---|
| | | | Amount | | | |
| | | | Dependence of | | | |
| | | | Luminous Flux | | | |
| | Alumina Content | | Ratio (%) | | | |
| | (Mass %) | | 0.005 | 0.016 | Layer | Total |
| Lamp | γ | α- | mg/cm² | mg/cm² | Adhesion | Luminous |
| No. | Alumina | Alumina | of Hg | of Hg | Strength | Flux (%) |
| (1) | 2 | 0 | 50 | 80 | ◯ | 100 |
| (2) | 1.5 | 0.5 | 70 | 90 | ◯ | 100 |
| (3) | 1.0 | 1.0 | 90 | 90 | ◯ | 100 |
| (4) | 0.5 | 1.5 | 90 | 90 | Δ | 100 |
| (5) | 0 | 2 | 90 | 90 | x | 98 |
| (6) | 0 | 3 | 90 | 90 | Δ | 96 |
| (7) | 0 | 5 | 90 | 90 | Δ | 95 |

As can be seen from this Table 1, lamps used for comparison, which contained a large amount of mercury, such as 0.016 mg/cm², showed good luminous flux ratios (luminous-flux rising characteristics), such as 80% or more, regardless of types of alumina particles (γ and α) contained in the fluorescent layer. However, since an excessive amount of the mercury was enclosed, it is not preferable in view of environmental conservation.

In addition, in lamps in which 0.005 mg/cm² of the mercury was enclosed and in which γ-alumina fine particles were contained in the fluorescent layer as alumina, when 2 mass % of γ-alumina fine particles was only contained (lamp (1)), the luminous-flux rising characteristics was disadvantageously decreased to 50%.

Moreover, because of a small total luminous flux and a small film adhesion strength, the lamps (5) to (7) are not preferable in which γ-alumina fine particles were not contained and in which a large amount of α-alumina fine particles, such as 2 mass % or more, was only contained.

Furthermore, because of a high total luminous flux, superior luminous-flux rising characteristics and high film adhesion strength, the lamps (2) to (4) are preferable in which 0.005 mg/cm² of mercury was enclosed and in which 0.5 to 1.5 mass % of γ-alumina fine particles and 0.5 to 1.5 mass % of α-alumina fine particles were contained in the fluorescent layer as alumina.

From the results shown in Table 1, it is recognized that when 1.0 to 1.5 mass % of γ-alumina fine particles having a BET value of 60 m²/g or more and 0.5 to 1.0 mass % of α-alumina fine particles having a BET value of 40 m²/g or less are contained together as alumina in the fluorescent layer, a high total luminous flux, superior luminous-flux rising characteristics and a high film adhesion strength can be preferably obtained.

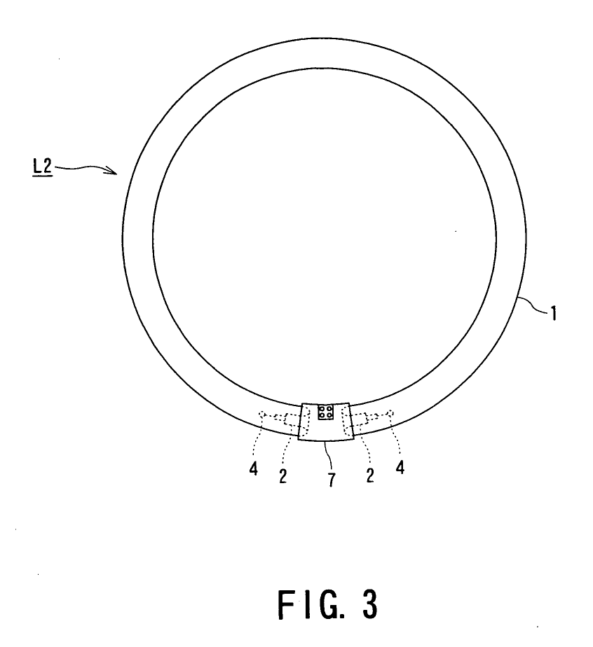

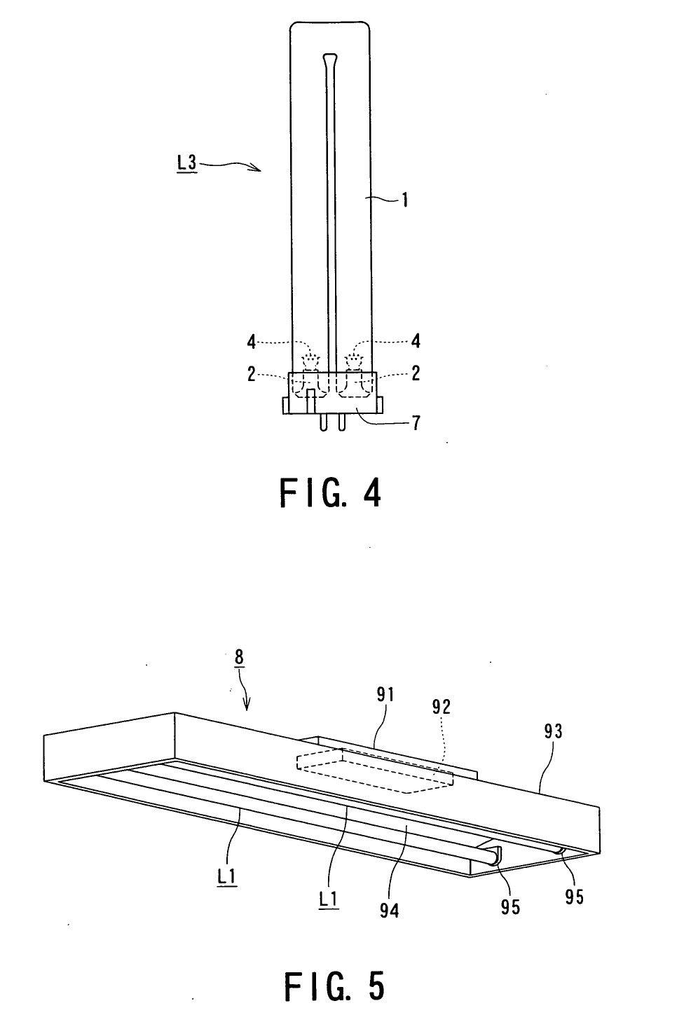

FIGS. 3 and 4 show fluorescent lamps according to other aspects of the embodiment of the present invention, in which FIG. 3 shows a circular type fluorescent lamp L2 having a ring-shaped glass bulb 1, and FIG. 4 shows a U-shaped type fluorescent lamp L3 having an approximately U-shaped glass bulb 1. The same reference numerals of the lamp L1 shown in FIG. 1 designate the same constitutional elements of the lamps L2 and L3, and descriptions thereof will be omitted herein.

The fluorescent lamps L2 and L3 are also formed of the fluorescent layer 6 containing γ-alumina fine particles and α-alumina fine particles as like as the straight type fluorescent lamp L1 of the above embodiment. Further, the fluorescent lamps L2 and L3 have the structure approximately equivalent to that of the straight type fluorescent lamp L1 except for the outer appearance of the bulb 1 and the base 7. These fluorescent lamps L2 and L3 also attain the effects substantially equal to those attained by the straight type fluorescent lamp L1 of the embodiment represented by FIGS. 1 and 2.

Further, although the fluorescent layer 6 of this embodiment is formed by mixing the phosphor fine particles, γ-alumina fine particles and α-alumina fine particles, according to the present invention, the fluorescent layer 6 may be formed by the steps of coating the surfaces of the phosphor fine particles with mixed alumina fine particles containing γ-alumina fine particles and α-alumina fine particles having the compositions described hereinbefore and dispersing the phosphor fine particles thus processed in PEO or the like to form a dispersion, followed by application and firing.

The fluorescent layer 6 formed by using the phosphor fine particles coated with the alumina fine particles as described above can attain an effect of preventing the adsorption of the mercury so that the oxidation thereof is suppressed. The consumption of the mercury during the lighting can be hence decreased.

For example, the rates of the mercury consumption when an FL40SS lamp is continuously placed in the ON state for 12,000 hours are approximately 70%, 50%, 40%, and 30% when approximately 30%, 50%, 70%, and 90% of the surfaces of the phosphor fine particles are covered, respectively, and hence a fluorescent lamp can be provided in which the degradation in light-emitting properties such as the luminous flux is small.

Moreover, when the fluorescent layer 6 is formed by using the phosphor material described above, since the amount of the enclosed mercury can be decreased to 0.007 mg/cm² or less, a preferable fluorescent lamp is obtainable in view of environmental conservation.

Furthermore, in a fluorescent lamp made of a glass bulb 1 having an inner diameter of 30 mm or less and a length of 1,000 mm or more, it was confirmed that a particularly significant effect is obtainable. This would be believed that as the inner diameter and the total length of the fluorescent lamp are increased, it takes a much time for the mercury condensed at the end portions of the bulb 1 to be uniformly diffused in the entire bulb 1. Moreover, in particular, in a case where the dispersion of the phosphor material for forming the fluorescent layer was an aqueous solution, preferable results were obtained.

FIG. 5 is a perspective view showing a lighting device (lighting equipment) 8 of a further embodiment of the present invention in which the straight type fluorescent lamp L1 of the first aspect of the first mentioned embodiment of the present invention is used.

Referring to FIG. 5, reference numeral 91 indicates a main body of the lighting device (equipment) 8 in which a mounting fitting for mounting the lighting device to a building or the like and a lighting circuit 92 such as a power connection member and a ballast are arranged. A shade 93 is provided below the main body 91, and the bases 7 of the two straight type fluorescent lamps L1 are fitted to sockets 95 which are mounted inside the shade 93 so as to support the two fluorescent lamps L1. Further, reference numeral 94 in FIG. 5 indicates a reflector.

The fluorescent lamps L1 are supplied with electricity through the lighting circuit 92, including the power connection member and the ballast, wires not shown in the figure and the sockets 95 to thereby maintain a stable light-on state.

Further, in the fluorescent lamps L1 fixed to the lighting device or equipment 8, the degradation in brightness does not occur over the entire surfaces of the lamps at the initial lighting stage, and hence, the lighting can be uniformly performed.

In the following, one preferred example of the lighting device according to the present invention will be described.

### EXAMPLE

For the inner surface of the bulb 1 of a straight type FL40SS fluorescent lamp, a three wavelength-emission type rare earth phosphor material in an amount of approximately 60 kg was prepared by mixing (Sr, Ba, Ca)₁₀(PO₄)₆Cl₁₂:Eu as a blue phosphor material, LaPO₄:Ce, Tb as a green phosphor material, and Y₂O₃:Eu as a red phosphor material at a mixing ratio of approximately 30:31:39 on a weight % basis. Subsequently, approximately 90 liters of an aqueous solution containing approximately 1% of PEO, approximately 600 g (approximately 1 mass % to the total of the phosphor fine particles) of γ-alumina fine particles having a BET value of approximately 125 m²/g, and approximately 600 g (approximately 1 mass % to the total of the phosphor fine particles) of α-alumina fine particles having a BET value of approximately 10 m²/g were added to the above mixture of the phosphor materials to form a fluorescent dispersion.

Next, after a protective layer was formed by applying approximately 50 mg of alumina fine particles to the inner surface of a glass tube having a length of approximately 1,200 mm and an outer diameter of approximately 29 mm, 3 to 4 g of the fluorescent dispersion, which was sufficiently stirred beforehand, was applied to the protective layer described above, which was followed by drying and baking, thereby forming the fluorescent layer 6. Subsequently, a step of sealing between the bulb 1 and mounts, an evacuation step, and a step of fixing the base were performed, thereby forming the fluorescent lamp.

In this fluorescent lamp, the BET value of the fluorescent layer 6 described above was approximately 1.2 m²/g, the amount of mercury enclosed in the bulb 1 was approximately 0.005 mg/cm², and except for the amount of mercury and the fluorescent layer 6 described above, the structure of the fluorescent lamp in this example was the same as that of an existing related fluorescent lamp.

Further, the respective BET values can be measured by peeling off only the fluorescent layer without peeling off the protection film (protective layer) from the fluorescent lamp.

The three-wavelength emission type fluorescent lamp thus formed had a color temperature of approximately 5,000K and a color deviation of +0.0002 as day white color of FL40SSEX-N/37, which were equivalent to those of an existing related lamp. In addition, even when this fluorescent lamp was turned on after being placed in a warehouse at room temperature for approximately three months, the fluorescent layer 6 was not peeled and the luminous-flux rising characteristics, which was measured right after the start of operation, was not degraded.

1. A fluorescent lamp comprising;
a glass bulb;
electrodes provided in the glass bulb;
a discharge medium enclosed inside the glass bulb, said discharge medium containing an inert gas and 0.009 mg/cm² or less of mercury per inner surface area of the glass bulb; and
a fluorescent layer provided on the inner surface of the glass bulb, the fluorescent layer containing phosphor fine particles and a binding agent composed of fine particles having a BET value of 60 m²/g or more and fine particles having a BET value of 40 m²/g or less.

2. The fluorescent lamp according to claim 1, wherein said binding agent comprises γ-alumina fine particles having a BET value of 60 m²/g or more and α-alumina fine particles having a BET value of 40 m²/g or less.

3. The fluorescent lamp according to claim 1, wherein an average BET value of the binding agent is in the range of from 40 to 80 m²/g.

4. The fluorescent lamp according to claim 1, wherein 3.0 mass % or less of the total fine particles of the binding agent is added to the phosphor fine particles.

5. The fluorescent lamp according to according to claim 4, wherein 1.5 mass % or less of γ-alumina fine particles having a BET value of 60 m²/g or more is added to the phosphor fine particles.

6. A fluorescent lamp comprising;
a glass bulb;
electrodes provided in the glass bulb;
a discharge medium enclosed inside the glass bulb, said discharge medium containing an inert gas and 0.009 mg/cm² or less of mercury per inner surface area of the glass bulb; and
a fluorescent layer provided on the inner surface of the glass bulb, the fluorescent layer having a BET value of 1.2 to 1.7 m²/g and containing phosphor fine particles and a binding agent.

7. The fluorescent lamp according to claim 6, wherein said binding agent comprises γ-alumina fine particles having a BET value of 60 m²/g or more and α-alumina fine particles having a BET value of 40 m²/g or less.

8. The fluorescent lamp according to claim 6, wherein an average BET value of the binding agent is in the range of from 40 to 80 m²/g.

9. The fluorescent lamp according to claim 6, wherein 3.0 mass % or less of the total fine particles of the binding agent is added to the phosphor fine particles.

10. The fluorescent lamp according to claim 9, wherein 1.5 mass % or less of γ-alumina fine particles having a BET value of 60 m²/g or more is added to the phosphor fine particles.

11. A fluorescent lamp comprising;
a glass bulb;
electrodes provided in the glass bulb;
a discharge medium enclosed inside the glass bulb, said discharge medium containing an inert gas and 0.009 mg/cm² or less of mercury per inner surface area of the glass bulb; and
a fluorescent layer provided on the inner surface of the glass bulb, the fluorescent layer having a BET value of 1.2 to 1.7 m²/g and containing phosphor fine particles and a binding agent, the binding agent containing fine particles having a BET value of 60 m²/g or more and fine particles having a BET value of 40 m²/g or less.

12. The fluorescent lamp according to claim 11, wherein said binding agent comprises γ-alumina fine particles having a BET value of 60 m²/g or more and α-alumina fine particles having a BET value of 40 m²/g or less.

13. The fluorescent lamp according to according to claim 11, wherein the average BET value of the binding agent is in the range of from 40 to 80 m²/g.

14. The fluorescent lamp according to according to claim 11, wherein 3.0 mass % or less of the total fine particles of the binding agent is added to the phosphor fine particles.

15. The fluorescent lamp according to claim 14, wherein 1.5 mass % or less of γ-alumina fine particles having a BET value of 60 m²/g or more is added to the phosphor fine particles.

16. A lighting device comprising:
a lighting main body;
a fluorescent lamp fitted to the lighting main body, the fluorescent lamp comprising: a glass bulb; electrodes provided in the glass bulb; a discharge medium enclosed inside the glass bulb, the discharge medium containing an inert gas and 0.009 mg/cm² or less of mercury per inner surface area of the glass bulb; and a fluorescent layer provided on the inner surface of the glass bulb, the fluorescent layer containing phosphor fine particles and a binding agent composed of fine particles having a BET value of 60 m²/g or more and fine particles having a BET value of 40 m²/g or less; and
a lighting circuit for the fluorescent lamp.

17. A lighting device comprising:
a lighting main body;
a fluorescent lamp fitted to the lighting main body, the fluorescent lamp comprising: a glass bulb; electrodes provided in the glass bulb; a discharge medium enclosed inside the glass bulb, the discharge medium containing an inert gas and 0.009 mg/cm² or less of mercury per inner surface area of the glass bulb; and a fluorescent layer provided on the inner surface of the glass bulb, the fluorescent layer having a BET value of 1.2 to 1.7 m²/g and containing phosphor fine particles and a binding agent; and
a lighting circuit for the fluorescent lamp.

18. A lighting device comprising:
a lighting main body;
a fluorescent lamp fitted to the lighting main body, the fluorescent lamp comprising: a glass bulb; electrodes provided in the glass bulb; a discharge medium enclosed inside the glass bulb, the discharge medium containing an inert gas and 0.009 mg/cm² or less of mercury per inner surface area of the glass bulb; and a fluorescent layer provided on the inner surface of the glass bulb, the fluorescent layer having a BET value of 1.2 to 1.7 m²/g and containing phosphor fine particles and a binding agent, the binding agent containing fine particles having a BET value of 60 m²/g or more and fine particles having a BET value of 40 m²/g or less; and
a lighting circuit for the fluorescent lamp.
